(19) United States
(12) Patent Application Publication
(10) Pub. No.: US 2004/0098291 A1
(43) Pub. Date: May 20, 2004

(54) Apparatus and method for visualizing resource consumption

(75) Inventor: Heath C. Newburn, Georgetown, TX (US)

Correspondence Address: DUKE W. YEE, CARSTENS, YEE & CAHOON, L.L.P., P.O. BOX 802334, DALLAS, TX, 75380, US

(73) Assignee: International Business Machines Corporation, Armonk, NY

(21) Appl. No.: 10/294,276

(22) Filed: Nov. 14, 2002

(51) Int. Cl. G06F 17/60

(52) U.S. Cl. 705/8

(57) ABSTRACT

A method and apparatus for visualizing the impact of deviations from a project plan are provided. With the present invention, a timeline with scheduled phases of the project is generated. For each phase of the project, a container of available resources is created. As work flows in, the containers are filled. If a container fills with work and there are less resources available than are required to perform the necessary work, remainder work exists, i.e. spillage occurs. This spillage may be compensated for by either adding resources to the container, expanding the time period of the container, or the like. If a container has an excess of resources beyond that needed to perform the work flowing into the container, then the work that would have been performed during this corresponding time period must be performed during a different phase of the project. In addition, because work that should have been performed in association with a particular container was not in fact performed, some amount of retooling, replanning, retraining, and the like, may be necessary to perform the work that was to be done previously in a later container along with the work that was originally scheduled for the later container. The combination of work not performed on schedule and the work required to perform retooling, replanning, retraining, etc. is termed “rework” and detracts from the available resources in the later container or phase of the project plan. The effects of spillage and rework on the project plan is visualized using the visualization tool described herein.

### BACKGROUND OF THE INVENTION

1. Technical Field

The present invention is directed to an improved data processing system and, in particular, an improved mechanism for visualizing resource consumption. Specifically, the present invention provides a mechanism for visualizing the impact of deviations of a project, with regard to consumption of resources, from a project plan.

2. Description of Related Art

It is often difficult for project managers to realize the impact of deviations of a project from a project plan. For example, slow downs or shortfalls in resources during certain phases of a project may have consequences on other phases of the project. The effects of such deviations and measures to compensate for such deviations in the project plan are often difficult for a project manager to determine.

Project management systems have been developed to help aid the project manager in visualizing a project plan. For example, U.S. Pat. No. 5,440,681 issued to Kudo describes a method and apparatus for the interactive modification of a production schedule using a graphical user interface. U.S. Pat. No. 5,563,994 issued to Harmon et al. describes a computer based system for generating graphic charts and textual representations identifying the temporal and sequential relationship between a plurality of tasks which must be performed to complete a project. U.S. Pat. No. 5,765,140 issued to Knudson et al. describes a dynamic project management system that includes a server network and a master database and wherein a project planning tool is used to effect the project plan including a plurality of tasks to be performed by the users in accordance with respective time schedules. Still other project management systems have been devised in addition to the ones set forth above.

While the above project management systems provide tools that aid the project manager in managing aspects of the project, these systems do not provide a graphical mechanism for aiding the project manager in visualizing consequences of overflow of work, rework, and the like, due to deviations of the progress of the project from a project plan.

Thus, it would be beneficial to have a method and apparatus for visualizing the effects of deviations in a project plan throughout the project.

### SUMMARY OF THE INVENTION

The present invention provides a method and apparatus for visualizing the impact of deviations from a project plan. With the present invention, a timeline with scheduled phases of the project is generated. For each phase of the project, a “container” or “bucket” of available resources is created. The container is a representation of available resources over a period of time. As work flows in, the containers are filled. If a container fills with work and there are less resources available than are required to perform the necessary work, a remainder of work exists, i.e. spillage occurs. This remainder may be compensated for by either adding resources to the container, expanding the time period of the container or the like.

If a container has an excess of resources beyond that needed to perform the work flowing into the container, then the work that would have been performed during this corresponding time period must be performed during a different phase of the project. In addition, because work that should have been performed in association with a particular container was not in fact performed, some amount of retooling, replanning, retraining, and the like, may be necessary to perform the work that was to be done previously in a later container along with the work that was originally scheduled for the later container. The combination of work not performed on schedule and the work required to perform retooling, replanning, retraining, etc. is termed “rework” and detracts from the available resources in the later container or phase of the project plan. Again, if the rework causes the available resources in a later phase to be less than is required for the work flowing into the container of the later phase, a remainder of work exits and the same options for compensating for this remainder as discussed above may be used.

The present invention may be used to help visualize project phases in order to perform project management and planning. Moreover, the present invention may be used to dynamically adjust resource availability and phase time periods to compensate for deviations of the project from an initial project plan.

These and other features and advantages of the present invention will be described in, or will become apparent to those of ordinary skill in the art in view of, the following detailed description of the preferred embodiments.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is an exemplary diagram illustrating a computing system according to the present invention;

FIG. 2 is an exemplary block diagram of a data processing system in which the present invention may be implemented;

FIG. 3 is a block diagram of a project planning visualization tool according to the present invention;

FIG. 4 is an exemplary diagram illustrating a display of a visualization tool according to the present invention; and

FIG. 5 is a flowchart outlining an exemplary operation of the present invention.

### DETAILED DESCRIPTION OF THE PREFERRED EMBODIMENT

With reference now to the figures and in particular with reference to FIG. 1, a pictorial representation of a data processing system in which the present invention may be implemented is depicted in accordance with a preferred embodiment of the present invention. A computer 100 is depicted which includes system unit 102, video display terminal 104, keyboard 106, storage devices 108, which may include floppy drives and other types of permanent and removable storage media, and mouse 110. Additional input devices may be included with personal computer 100, such as, for example, a joystick, touchpad, touch screen, trackball, microphone, and the like. Computer 100 can be implemented using any suitable computer, such as an IBM eServer computer or IntelliStation computer, which are products of International Business Machines Corporation, located in Armonk, N.Y. Although the depicted representation shows a computer, other embodiments of the present invention may be implemented in other types of data processing systems, such as a network computer. Computer 100 also preferably includes a graphical user interface (GUI) that may be implemented by means of systems software residing in computer readable media in operation within computer 100.

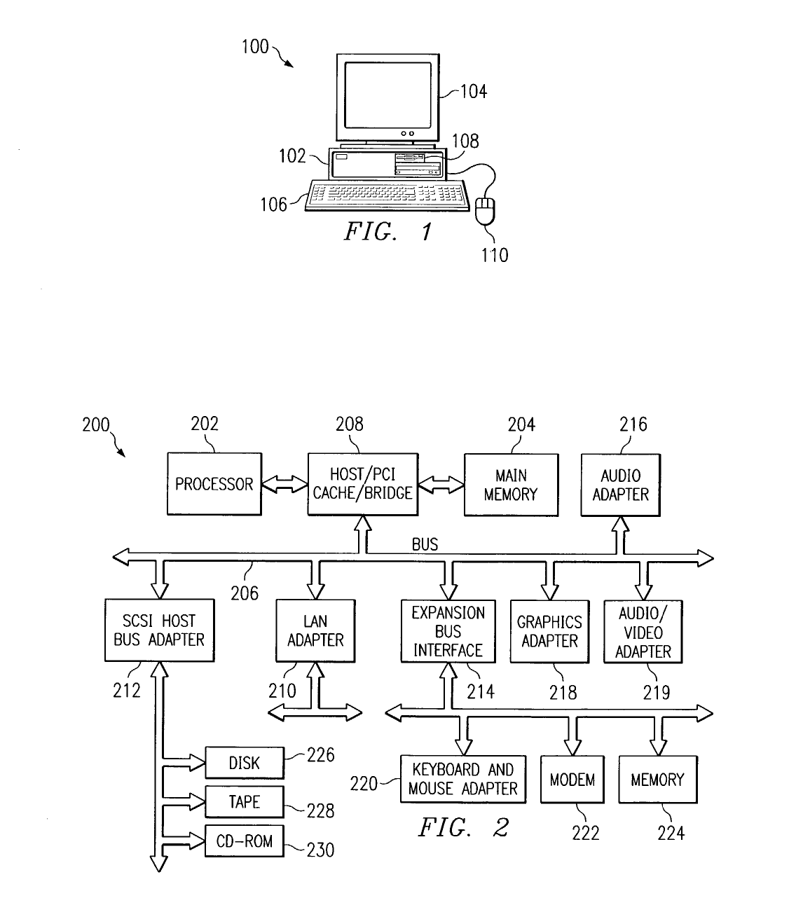

With reference now to FIG. 2, a block diagram of a data processing system is shown in which the present invention may be implemented. Data processing system 200 is an example of a computer, such as computer 100 in FIG. 1, in which code or instructions implementing the processes of the present invention may be located. Data processing system 200 employs a peripheral component interconnect (PCI) local bus architecture. Although the depicted example employs a PCI bus, other bus architectures such as Accelerated Graphics Port (AGP) and Industry Standard Architecture (ISA) may be used. Processor 202 and main memory 204 are connected to PCI local bus 206 through PCI bridge 208. PCI bridge 208 also may include an integrated memory controller and cache memory for processor 202. Additional connections to PCI local bus 206 may be made through direct component interconnection or through add-in boards. In the depicted example, local area network (LAN) adapter 210, small computer system interface SCSI host bus adapter 212, and expansion bus interface 214 are connected to PCI local bus 206 by direct component connection. In contrast, audio adapter 216, graphics adapter 218, and audio/video adapter 219 are connected to PCI local bus 206 by add-in boards inserted into expansion slots. Expansion bus interface 214 provides a connection for a keyboard and mouse adapter 220, modem 222, and additional memory 224. SCSI host bus adapter 212 provides a connection for hard disk drive 226, tape drive 228, and CD-ROM drive 230. Typical PCI local bus implementations will support three or four PCI expansion slots or add-in connectors.

An operating system runs on processor 202 and is used to coordinate and provide control of various components within data processing system 200 in FIG. 2. The operating system may be a commercially available operating system such as Windows XP, which is available from Microsoft Corporation. An object oriented programming system such as Java may run in conjunction with the operating system and provides calls to the operating system from Java programs or applications executing on data processing system 200. “Java” is a trademark of Sun Microsystems, Inc. Instructions for the operating system, the object-oriented programming system, and applications or programs are located on storage devices, such as hard disk drive 226, and may be loaded into main memory 204 for execution by processor 202.

Those of ordinary skill in the art will appreciate that the hardware in FIG. 2 may vary depending on the implementation. Other internal hardware or peripheral devices, such as flash read-only memory (ROM), equivalent nonvolatile memory, or optical disk drives and the like, may be used in addition to or in place of the hardware depicted in FIG. 2. Also, the processes of the present invention may be applied to a multiprocessor data processing system.

For example, data processing system 200, if optionally configured as a network computer, may not include SCSI host bus adapter 212, hard disk drive 226, tape drive 228, and CD-ROM 230. In that case, the computer, to be properly called a client computer, includes some type of network communication interface, such as LAN adapter 210, modem 222, or the like. As another example, data processing system 200 may be a stand-alone system configured to be bootable without relying on some type of network communication interface, whether or not data processing system 200 comprises some type of network communication interface. As a further example, data processing system 200 may be a personal digital assistant (PDA), which is configured with ROM and/or flash ROM to provide non-volatile memory for storing operating system files and/or user-generated data.

The depicted example in FIG. 2 and above-described examples are not meant to imply architectural limitations. For example, data processing system 200 also may be a notebook computer or hand held computer in addition to taking the form of a PDA. Data processing system 200 also may be a kiosk or a Web appliance. The processes of the present invention are performed by processor 202 using computer implemented instructions, which may be located in a memory such as, for example, main memory 204, memory 224, or in one or more peripheral devices 226-230.

As discussed above, the present invention provides a mechanism for visualizing a project plan and for visualizing deviations of a project from the project plan as well as how such deviations affect other portions of the project. Moreover, through use of the visualization tool of the present invention, a user may adjust parameters of portions of the project in order to visualize how compensation for deviations may be made.

With the present invention, a timeline with scheduled phases of the project is generated. For each phase of the project, a container of available resources is created. Thus, the container represents a number of available resources over a period of time.

As work flows in, e.g., work is assigned to a particular phase of the project plan, the containers for each phase are filled. If a container fills with work and there are less resources available than are required to perform the necessary work, a remainder of work exists, i.e. spillage occurs. This remainder or spillage may be compensated for by either adding resources to the container or expanding the time period of the container.

If a container has an excess of resources beyond that needed to perform the work flowing into the container, then the work that would have been performed during this corresponding time period must be performed during a different phase of the project. In addition, because work that should have been performed in association with a particular container was not in fact performed, some amount of retooling, replanning, retraining, and the like, may be necessary to perform the work that was to be done previously in a later container along with the work that was originally scheduled for the later container. The combination of work not performed on schedule and the work required to perform retooling, replanning, retraining, etc. is termed “rework” and detracts from the available resources in the later phase. Again, if the rework causes the available resources in a later phase to be less than is required for the work flowing into the container of the later phase, a remainder of work exists and the same options for compensating for this remainder as discussed above may be used.

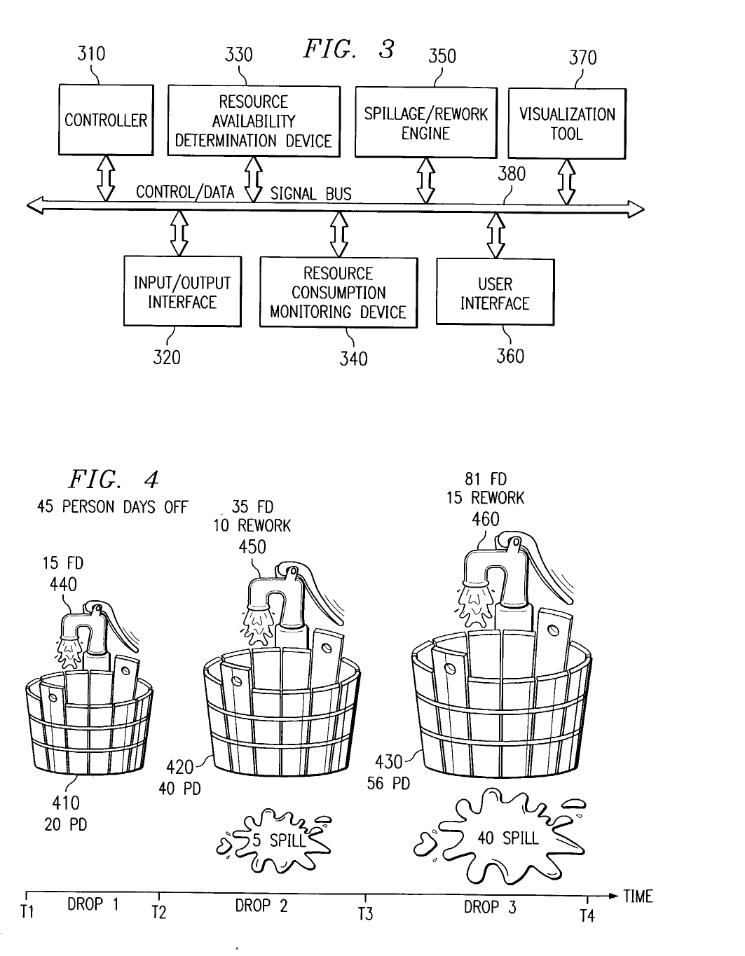

FIG. 3 is an exemplary block diagram of a resource consumption visualization tool in accordance with the present invention. A shown in FIG. 3, the resource consumption visualization tool includes a controller 310, an input/output interface 320, a resource availability determination device 330, a resource consumption monitoring device 340, a spillage/rework engine 350, a user interface 360 and a visualization tool 370. The elements 310-370 are coupled to one another via the control/data signal bus 380. The elements 310-370 in FIG. 3 may be implemented in hardware, software, or any combination of hardware and software. In a preferred embodiment of the present invention, the elements 310-370 are implemented as software instructions executed by one or more processors.

The controller 310 controls the overall operation of the resource consumption visualization tool and orchestrates the operation of the other elements 320-370. The input/output interface 320 provides a communication mechanism through which data may be obtained, such as resource availability and consumption data, and through which the visualizations of the present invention may be output to a display device for use by a user in determining the impact of deviations in resource consumption from a predetermined project plan.

The resource availability determination device 330 obtains resource availability data from a source device pertaining to the resources that will be available throughout a project plan. The data may be obtained from any of a number of sources including, for example, a project plan data file in which resource availability is outlined according to a project plan. Other example sources of resource availability data may be, for example, historical information pertaining to resource availability, collected and stored in a historical data file for use by the present invention. In an alternative embodiment, the resource availability determination device 330 may communicate with a timekeeping and/or inventory system via the input/output interface 320, to obtain information from such systems regarding resource availability.

In a preferred embodiment, the present invention is used as a predictive engine to predict the impact of deviations of resource consumption, work scheduling, and the like, on a project plan. As such, the actual resource consumption may be simulated based on parameters defining expected possible deviations from the predefined project plan. Based on these expected possible deviations, various scenarios may be devised and simulated through the use of the present invention.

The resources referred to in the present invention may be any resources that are consumed in the completion of a project. For example, the resources may include man hours, computing cycles, raw materials, currency, and the like. Furthermore, the resources referred to in the present invention may be of the same or different types. Thus, for example, the present invention may be used on a general scale where “resources” represents all of the resources used to complete a project. Alternatively, the present invention may be used for each individual type of resource used to complete a project. In the alternative embodiment, if a project requires different types of resources, multiple executions of the present invention may be used, one for each type of resource consumed in the completion of the project.

In a preferred embodiment, the particular inputs to the resource consumption visualization tool are defined by the upstream process, e.g., timekeeping/inventory control program or the like. The amount of work that is to be done is provided as an input from a user. A common metric for units of work is defined and the amount of work is converted to the units of the common metric, e.g., person-hours, lab-hours, number of pieces, etc.

Based on the available resource information obtained by the resource availability determination device 330, containers of resource availability are defined for predetermined time periods of a project timeline. These containers are utilized by the other elements of the resource consumption visualization tool to determine the impact of deviations of resource consumption from that which is expected, such as that defined in a project plan or the like.

The resource consumption monitoring device 340 monitors the consumption of resources as work flows into the system for a particular project, i.e. as particular units of work are identified for a particular container of a project plan. This work has resource consumption associated with it which is used to determine if the container has sufficient resource availability to contain the unit of work, e.g., the work flowing in is 10 units of work which consumes 20 person days. Thus, there is a correspondence between a unit of work and an amount of resources consumed by that unit of work. This correspondence may be established by the project manager or other user.

The particular units of work are defined by the project. The units of work will typically be much smaller than the average container capacity so that any unit of work will fit within a container. It is when the resources within the container are already assigned to other units of work that a remainder of work, or spillage, may occur.

For example, if the project is a software package, the work effort can be defined in the number of line items or requirements (and the number of line items that can either be coded/tested/translated, etc.) or in person hours (the most common form). Work flows in as raw materials become available to an assembly line, when requirements become defined in a coding process, or code becomes available in a software testing process. The sizing for the consumed resource and the capacity to handle it are jointly defined by the owner of the resource and the owner of the process consuming it.

As work “flows” into the containers defined by the resource availability determination device 330, the spillage/rework engine 350 determines if the container has resource availability to contain the unit of work, i.e. has enough remaining capacity with regard to resources, to handle the unit of work. In other words, a determination is made as to whether the available resources for a container is larger than the resource consumption associated with the unit of work.

If the available resources is greater than the resource consumption associated with the unit of work, then the unit of work is assigned to that container and the available resources are reduced by the amount of the resource consumption associated with the unit of work.

If the available resources is not greater than the resource consumption, then a remainder of work exists, i.e. spillage occurs. In such a case, since there are not enough resources to complete the unit of work, the unit of work, or a portion thereof, spills over into the next defined container. This causes the available resources of the next defined container to be reduced by the amount of the spillage. This may cause the next defined container to spill over into its next defined container, and so on, causing a domino effect.

Once all the units of work for a particular container have been assigned, it is possible that more resources are allocated for a container than are utilized by the units of work. In this case, resources lay idle that were allocated for use by the original project plan. Therefore, it can be determined that the amount of work that was to be performed using these idle resources will have to be done in a later phase or container. As a result, resources will be expended at a later time to make up for the idleness of the resources in the present container. This effectively reduces the resource availability of the later container.

In addition, since the work that could have been done in a previous phase was not performed during that phase, and must be done in a different phase, there is an amount of work for retooling, retraining, and replanning that must be accounted for. The total amount of work required for performing this additional “left over” work is “rework.”

The spillage/rework engine 350 determines the amount of remainder work, or spillage, and/or rework for each of the containers as well the amount of resources consumed by the units of work assigned to each container. This information may be stored in a data structure in a storage device (not shown) for later use by the visualization tool 370 to generate the display of the project plan, the deviations from the project plan, and the impact of these deviations, e.g., spillage and rework and the associated affects of this spillage and rework on resource availability of later containers in the project timeline.

The visualization tool 370 generates a graphical user interface based display of the containers, consumed resources, available resources, spillage, rework, etc., determined using the resource availability determination device 330, the resource consumption monitoring device 340, and the spillage/rework engine 350. The display is provided as a graphical user interface so that a user may manipulate the containers' sizes and/or the available resources associated with the containers in order to see the affect of such modifications on the overall project plan. In this way, a user may compensate for spillage and rework before the spillage and rework are actually experienced.

A user interface 360 is provided such that the user may manipulate portions of the graphical user interface provided by the visualization tool 370 to determine the affects of changes of the containers will cause on the overall project plan. For example, a user may manipulate the graphical user interface to change the size of the containers, in terms of time, and determine how such resizing of the containers will affect other containers, resource availability, spillage, rework, etc. That is, resources are made available at various time points and units of work are assigned at various time points. By adjusting the time period of a container, i.e. the width of the container, different sets of time points are included within the container. As a result, different amounts of system resources are available in the container and different amounts of work are assigned to that container. This resizing has an affect on the surrounding container that is determined and depicted in the resulting graphical user interface after the manipulation of the container.

In other words, time is viewed as another resource. It may take a group of people a certain amount of time to do a particular amount of work. When the time is stretched, the same number of people can do more of that work. However, the converse is not always true. That is, when more work is added into an existing container, it may not always be possible to add more people and get full efficiencies, e.g., nine women can not make a baby in one month. Thus, if more time can be made available, if the schedule allows it, the amount of work can be reduced.

Similarly, the user may adjust the amount of resources made available in each container to determine how such changes may affect other containers as well as the project plan as a whole. That is, the user may wish to see how allocating additional resources during different containers will change the project plan and the ability to meet it. Of course, such modifications may be bounded by the total amount of resources that may be made available for each container. That is, for example, an upper bound may be set based on the total number of employees available.

The modifications to the project plan may be made by manipulating the graphical user interface. For example, boundaries of containers may be moved using a pointing device, graphical elements representing the number of resources allocated to a container may be moved, and the like. When such modifications are made, the user may select an option to recompute the visual display to determine how the manipulations affect the project plan. Alternatively, the affects of such manipulations may be visualized dynamically as the user makes the modifications. Such recalculation may involve the controller 310 instructing the resource availability determination device 330, resource consumption monitoring device 340 and spillage/rework engine 350 to perform their operations again based on the changes made by the user.

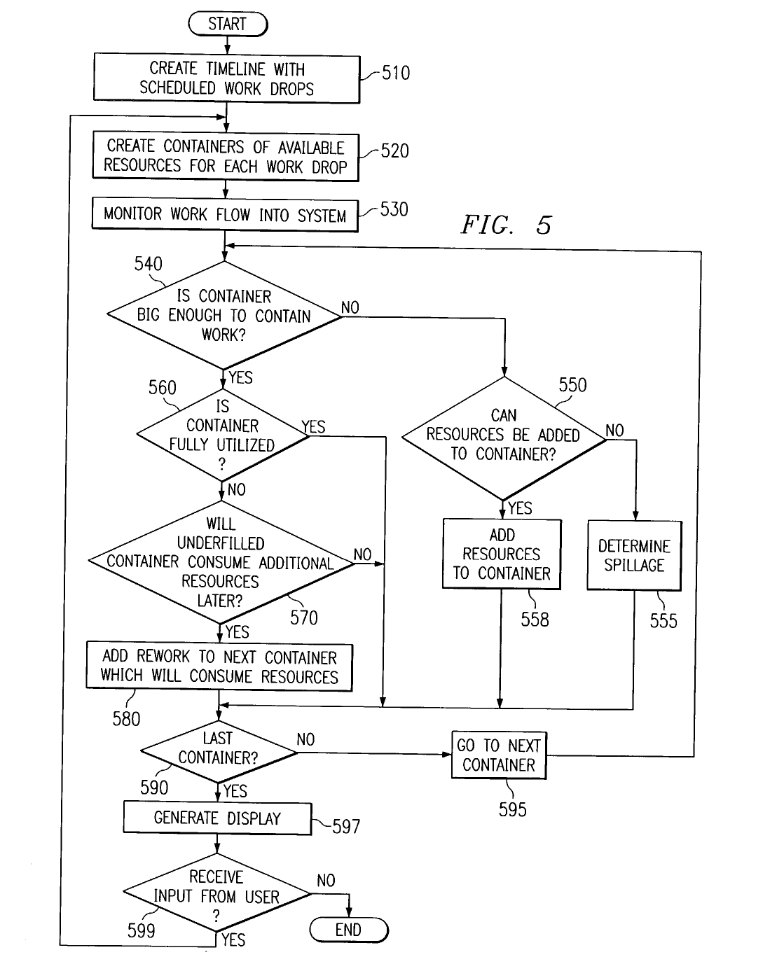

FIG. 4 is an exemplary illustration of a display of a project plan according to an exemplary embodiment of the present invention. As shown in FIG. 4, a project is broken up into drops, or phases, with each drop having a container 410-430 of a particular size (represented as wooden buckets in the figure). In the depicted example, the size of each container, or bucket, is defined by the number of person days (PD) represented by the bucket. The number of person days (PD) is the resource availability or available capacity of the bucket.

The various buckets and their size represent a project plan with regard to resource consumption. That is, a user that enters a project plan into the visualization tool of the present invention provides the number of person days that are to be allotted to each drop or phase of the project plan. Thus, if the project is to proceed according to the project plan, each bucket's capacity will be completely filled with no spillage and no rework required. However, in reality, project plans are rarely achieved as originally planned. The present invention visualizes what happens when the project plan is not achieved.

The amount of work that is performed during a particular phase or drop is represented as function days (FD) and is depicted as a water pump 440-460 filling the buckets. Function days and person days are synonymous, however the different terminology is used to denote one being associated with work flowing into the container, or bucket, and the other representing the resource capacity of the container. In the depicted example, drop 1 has a bucket with a capacity of 20 person days. Only 15 function days of work are performed during the time period of drop 1 and thus, there is 5 function days of work that could have been performed during drop 1 that were not. This 5 function days of work must be performed in a later drop and thus, constitutes 5 days of rework.

This 5 days of rework has a further cost associated with it in terms of retooling, retraining, replanning, etc. For example, in a previous stage of production, a team may make 50% of the red widgets that were supposed to be made because of lack of raw materials. In a current stage, the team may have started making green widgets, but not enough red widgets were made in the previous stage. Therefore, the team must make the green widgets, stop production of the green widgets, retool for production of red widgets, and then start producing red widgets. The assessment of the cost of rework must be made by the project team.

The amount of extra rework required to perform this retooling, retraining, replanning, etc. may be estimated as a function of the amount of excess capacity in the prior drop. For example, the user that configures the project plan may set forth parameters indicating that any rework in a subsequent drop will be 1.5 times the excess capacity of a previous drop. Of course, more complex functions may be used to obtain better estimates of the amount of rework caused by the excess capacity in a drop which may include a more detailed analysis regarding the type of work to be performed, the staffing of specialized individuals to perform the work, etc., that may influence the amount of replanning, retraining, retooling, etc. that must be done.

In the depicted example, the amount of rework caused by the excess capacity in bucket 410 and the necessary retooling, retraining, etc., is represented as 10 Rework days. As a result, the amount of work flowing into bucket 420 is 10 Rework days plus the regular flow of 35 function days of work, for a total of 45 person days. Bucket 420 only has a capacity of 40 person days and as a result, there is spillage of 5 person days of work.

Bucket 430 has a capacity of 56 person days. However, there is 81 function days of work flowing into this bucket along with 15 rework days. The 15 rework days are based on a determination that the retooling, retraining, etc., will take 5 people 3 days, consuming 15 person days of rework that does not advance the progress but is the cost of moving the work to a later point in the schedule. Thus, a total of 96 person days of work is flowing into bucket 430 which only has capacity to handle 56 person days of work. As a result, there is spillage of 40 person days.

From this depiction of the project plan, a user may determine that the project will be 45 person days off from the project plan. The user may then attempt to change the amount of resources in the buckets to compensate for the 45 days. For example, the user may change the size of bucket 410 to be 15 person days and add 5 person days to the capacity of bucket 420. This will eliminate the 5 person days of spillage from bucket 420. In order to compensate for the 40 person day spillage in bucket 430, if the schedule permits, the user may add an additional drop and bucket between 420 and 430 that has a capacity of 25 person days. Another drop and bucket may be added after bucket 430 that has a capacity of 15 person days. As a result, the project will only be 15 person days off from the original project plan rather than 45 days off. Of course there may be many different ways that the user may attempt to compensate for the number of person days off by manipulating the size and number of drops and buckets, the amount of work flowing into each drop or bucket, etc., with each possibility being handled by the visualization tool of the present invention.

In an exemplary embodiment, when it is determined that there is excess capacity in a bucket, such as bucket 410, a determination is made as to whether the excess capacity represents work that was not done that will negatively impact other buckets. It may be the case that the buckets are provided with excess capacity in order to provide a safety buffer in case of delay in the performance of the work. In such a case, the excess capacity may not require additional work to be performed in a later bucket. If the excess capacity will not negatively affect other buckets, the rework discussed above is not added to the other buckets.

In addition, when it is determined that there will be spillage due to a lack of capacity of a bucket for the work flowing into the bucket, a determination may be made as to whether there are additional resources that may be added to compensate for the spillage. Thus, for example, when it is determined that there will be spillage in bucket 420, a determination may be made as to whether there are an additional 5 person days of resources available between buckets 420 and 430. If so, the size of bucket 430 may be automatically expanded to a size of 45 person days to handle the spillage.

In the depicted example, and in a preferred embodiment, the various resources required to perform the work of the project are reduced to a common unit of work, e.g., person days. However, in more complex examples of the present invention, the width of the buckets may be representative of time while the height (or depth) of the bucket may be representative of resources or a particular resource. In this way, the user may manipulate two parameters of the buckets 410-430 to see how they would affect the rest of the drops of the project. Of course the present invention may be extended to three dimensions with one resource being represented in a first dimension, a second resource being represented in a second dimension, and a third resource being represented in a third dimension. In this way, the user may make various manipulations of the resources to determine the optimum adjustments to the project plan to achieve a desired result.

FIG. 5 is a flowchart outlining an exemplary operation of the present invention. As shown in FIG. 5, the, operation starts with the creation of a timeline with scheduled work drops (step 510). Containers, or buckets, are created with available resources for each work drop (step 520). The work flow is then monitored (step 530) and a determination is made as to whether a container has sufficient size and available resources to contain a work drop (step 540). If not, a determination is made as to whether resources can be added to the container (step 550). If so, the resources are added to the container (step 558). If not, the amount of spillage is determined (step 555).

If the container is large enough to contain the work drop (step 540), a determination is made as to whether the container is fully utilized (step 560). If not, a determination is made as to whether the underutilization will consume additional resources in a later container (step 570). If so, rework is added to the next container which will consume the resources (step 580).

Thereafter, a determination is made as to whether the container is the last container (step 590). If not, the operation goes to the next container (step 595) and returns to step 540. It should be appreciated that the next container may include spillage or rework from a previous container and thus, the determination of step 540 is not based entirely on only the work drop assigned to that container.

If the container is the last container (step 590), the display is generated (step 597) and a determination is made as to whether user input is received (step 599). If so, the operation returns to step 520 to perform the method of the present invention based on modifications made by the user. Otherwise, the operation terminates.

Thus, the present invention provides a mechanism for visualizing the impact of deviations in a project plan based on changes in resource consumption. The present invention provides a user with an easily understandable representation of spillage and rework that may be required due to inefficient use of allocated resources. Furthermore, the present invention provides a mechanism by which a user may explore various changes to a project plan to compensate for inefficient use of allocated resources.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, in a data processing system, for visualizing a project plan, comprising:
receiving user input defining a project plan, wherein the project plan includes a timeline for the project and one or more parameters regarding resources available along the timeline;
defining a plurality of container data structures representing available resource capacity based on the timeline and the one or more parameters;
identifying an amount of work flowing into one or more container data structures of the plurality of container data structures, the work having an associated resource consumption;
determining if there is sufficient remaining resource capacity in the one or more container data structures for the work flowing into the one or more container data structures; and
generating a graphical representation on a display device of the data processing system that depicts the plurality of container data structures based on the amount of work flowing into the one or more container data structures and the determination of whether there is sufficient remaining capacity in the one or more container data structures for the work flowing into the one or more container data structures.

2. The method of claim 1, further comprising:
determining an amount of rework required if the work flowing into the one or more container data structures is less than a resource capacity of the one or more container data structures.

3. The method of claim 2, wherein generating a graphical representation includes generating a graphical representation of the amount of rework.

4. The method of claim 1, further comprising:
receiving user input to adjust the characteristics of the one or more container data structures;
redetermining if there is remaining available capacity in the one or more container data structures for the work flowing into the one or more container data structures; and
revising the graphical representation of the plurality of container data structures based on the user input and redetermination of remaining available capacity.

5. The method of claim 4, wherein the user input includes one of increasing a number of resources available for the one or more container data structures and increasing a time period represented by the one or more container data structures.

6. The method of claim 2, wherein determining an amount of rework includes calculating the amount of rework as a function of excess capacity in a prior container data structure of the plurality of containers.

7. The method of claim 1, further comprising:
determining an amount of remainder work if the amount of work flowing into the one or more container data structures exceeds a capacity of the one or more container data structures.

8. The method of claim 7, wherein generating a graphical representation includes generating a graphical representation of the amount of remainder work.

9. The method of claim 2, wherein determining an amount of rework includes determining if an excess capacity of a prior container data structure in the plurality of container data structures represents work that was scheduled to flow into the prior container data structure but did not.

10. The method of claim 1, further comprising:
determining an amount of one or more of remainder work and rework with regard to the one or more container data structures; and
automatically adjusting parameters of the one or more container data structures based on the determination of one or more of remainder work and rework.

11. A computer program product in a computer readable medium for visualizing a project plan, comprising:
first instructions for receiving user input defining a project plan, wherein the project plan includes a timeline for the project and one or more parameters regarding resources available along the timeline;
second instructions for defining a plurality of container data structures representing available resource capacity based on the timeline and the one or more parameters;
third instructions for identifying an amount of work flowing into one or more container data structures of the plurality of container data structures, the work having an associated resource consumption;
fourth instructions for determining if there is sufficient remaining resource capacity in the one or more container data structures for the work flowing into the one or more container data structures; and
fifth instructions for generating a graphical representation on a display device of the data processing system that depicts the plurality of container data structures based on the amount of work flowing into the one or more container data structures and the determination of whether there is sufficient remaining capacity in the one or more container data structures for the work flowing into the one or more container data structures.

12. The computer program product of claim 11, further comprising:
sixth instructions for determining an amount of rework required if the work flowing into the one or more container data structures is less than a resource capacity of the one or more container data structures.

13. The computer program product of claim 12, wherein the fifth instructions for generating a graphical representation includes instructions for generating a graphical representation of the amount of rework.

14. The computer program product of claim 11, further comprising:
sixth instructions for receiving user input to adjust the characteristics of the one or more container data structures;
seventh instructions for redetermining if there is remaining available capacity in the one or more container data structures for the work flowing into the one or more container data structures; and
eighth instructions for revising the graphical representation of the plurality of container data structures based on the user input and redetermination of remaining available capacity.

15. The computer program product of claim 14, wherein the user input includes one of increasing a number of resources available for the one or more container data structures and increasing a time period represented by the one or more container data structures.

16. The computer program product of claim 12, wherein the sixth instructions for determining an amount of rework includes instructions for calculating the amount of rework as a function of excess capacity in a prior container data structure of the plurality of containers.

17. The computer program product of claim 11, further comprising:
sixth instructions for determining an amount of remainder work if the amount of work flowing into the one or more container data structures exceeds a capacity of the one or more container data structures.

18. The computer program product of claim 17, wherein the fifth instructions for generating a graphical representation includes instructions for generating a graphical representation of the amount of remainder work.

19. The computer program product of claim 12, wherein the sixth instructions for determining an amount of rework includes instructions for determining if an excess capacity of a prior container data structure in the plurality of container data structures represents work that was scheduled to flow into the prior container data structure but did not.

20. The computer program product of claim 11, further comprising:
sixth instructions for determining an amount of one or more of remainder work and rework with regard to the one or more container data structures; and
seventh instructions for automatically adjusting parameters of the one or more container data structures based on the determination of one or more of remainder work and rework.

21. An apparatus for visualizing a project plan, comprising:
means for receiving user input defining a project plan, wherein the project plan includes a timeline for the project and one or more parameters regarding resources available along the timeline;
means for defining a plurality of container data structures representing available resource capacity based on the timeline and the one or more parameters;
means for identifying an amount of work flowing into one or more container data structures of the plurality of container data structures, the work having an associated resource consumption;
means for determining if there is sufficient remaining resource capacity in the one or more container data structures for the work flowing into the one or more container data structures; and
means for generating a graphical representation on a display device of the data processing system that depicts the plurality of container data structures based on the amount of work flowing into the one or more container data structures and the determination of whether there is sufficient remaining capacity in the one or more container data structures for the work flowing into the one or more container data structures.
